(19) United States
(12) Patent Application Publication
(10) Pub. No.: US 2002/0170735 A1
(43) Pub. Date: Nov. 21, 2002

(54) Electric cable joints and methods of making them

(75) Inventors: Alan James Broad, Cornwall (GB); Graham Peter Lindsey, Kent (GB); Laurence Richard Trim, Kent (GB)

Correspondence Address: FINNEGAN, HENDERSON, FARABOW, GARRETT &, DUNNER LLP, 1300 I STREET, NW, WASHINGTON, DC, 20006, US

(73) Assignee: BICC General UK Cables Limited.

(21) Appl. No.: 10/034,374

(22) Filed: Jan. 3, 2002

Related U.S. Application Data
(63) Continuation of application No. 09/486,898, filed on Jun. 2, 2000, now abandoned.
Application No. 09/486,898 is a 371 of international application No. PCT/GB98/02662, filed on Sep. 3, 1998.

(30) Foreign Application Priority Data
Sep. 5, 1997 (GB) 9718925.2

(51) Int. Cl. H02G 3/06

(52) U.S. Cl. 174/84 R

(57) ABSTRACT

An electric cable joint arrangement includes two cables each having a cable end. Each cable has a metallic conductor surrounded by extruded polymeric insulation. Contiguous ends of the conductors are aligned and connected together by a joint, a screen extending over the joint, and a resilient insulating body shrunk onto the insulation to insulate the joint arrangement. At least one pin extends through a close-fitting bore in the insulation of each cable end and is embedded into the conductor. The screen extends over each pin. An associated method includes exposing insulation, forming at least one bore through the insulation, driving a pin through each bore until the pin is embedded into the conductor, aligning and connecting together ends of the metallic conductors, and providing a screen extending over a conductor joint and an area of each of the pin and a resilient insulating body shrunk onto the cable insulation.

This invention relates to joints for electric cables and to methods of making them. More particularly, it relates to joints for cables with polymeric insulation for service at high voltages (including “supertension” cables).

Such cables are manufactured by an extrusion process followed usually by heat-treatment for curing (crosslinking) and almost always by force cooling with water, and it is inherent in this process that there are residual stresses in the insulation. It is desirable to joint such cables with resilient insulating bodies that are shrunk onto the cable insulation by release of inherent elasticity (on withdrawal of a support on which the body was previously stretched) or by heat-shrink techniques, and such bodies apply to the insulation substantial forces that may vary substantially with load cycling of the cable in service. If such stresses result in any substantial movement of the end of the cable insulation, a void may arise by various mechanisms and may ultimately result in electrical discharges and failure of the joint.

WO86/02210 (=EP0199742) describes a technique in which grooves are cut into the circumferential surface of the insulation on each cable and internal flanges on a metallic sleeve surrounding the conductor joint area enter the grooves to provide a mechanical interlock from the insulation of one cable to the insulation of the other. This technique is in commercial use, but does not altogether eliminate the risk because it is only effective to the extent that the flanges are dimensioned to bear effectively on both sides of the respective groove in which they engage, which is not only dependent on the dimensional accuracy of cutting but also on the absence of any relative movement after the grooves have been cut and before the sleeve can be fitted and on the dimensional accuracy and reproducibility of the conductor jointing process; indeed it may become wholly ineffective if the two cable ends should behave differently and produce a substantial resultant force on the metallic sleeve; this is a real risk, especially since it is frequently necessary to joint cables that differ in age, in insulation formulation, in manufacturing source, in thermal history (all of which may substantially affect the residual stresses in the insulation), in design electrical stress (and therefore in insulation thickness), in conductor size (and therefore in insulation diameter) or in more than one of these.

The present invention provides joints, and methods of making them, which are tolerant of the small dimensional variations that are likely to be encountered and in which the insulation can be secured at an early stage in the jointing process, if desired even before the step of cutting back the insulation to expose the metallic conductor, and which are effective even if the insulation ends behave quite differently.

In accordance with one aspect of the invention, an electric cable joint between two cables each having a metallic conductor surrounded by extruded polymeric insulation comprises at least one pin of relatively hard material extending in a generally radial direction through a close-fitting bore in the insulation of each cable and embedded into the metallic conductor within it, contiguous ends of the metallic conductors being aligned and connected together by a conductor joint, screening means extending over the conductor joint and the area of each said pin, and a resilient insulating body shrunk onto the cable insulation to insulate the joint.

The invention is primarily intended for use in “onepiece” joints in which the resilient insulating body provides the whole of the joint insulation, but may also be applied to some designs of composite joint in which the resilient insulating body will be an electrical stress control cone for one of the cable ends.

Cables to which the present invention is applicable will almost always have a semiconducting conductor screen bounding the insulation on its inner surface and a semiconducting dielectric screen bounding it on its outer surface, a surrounding watertight sheath (jacket) and, if the sheath is insulating, a metallic screen between the dielectric screen and the jacket. In the case of a cable with more than one conductor (in practice usually a three-core or four-core cable), the sheath and possibly the metallic screen will be common to all the conductors; this option is seldom used at the voltages for which this invention is primarily intended, and does not require further discussion, since the changes required are routine ones.

The dielectric screen will be cut back from the joint area and either reinstated over the resilient insulating body (or by a semiconducting outer layer forming part of it) or terminated at each end of the joint in a stress cone shaped to limit concentrations of electrical stress. The sheath (and metallic shield if present) will be cut back and reinstated in the normal way.

Preferably the screening means extending over the conductor joint and the area of the pins is or includes a semiconducting tubular insert within (and forming part of) the resilient insulating body.

Preferably there is at least one pair of pins for each of the two cable ends, to preserve symmetry and allow the forces required to insert the pins to balance each other. Two or three pairs of pins for each cable end will usually be preferred.

Each pin should be a close fit in the bore provided in the insulation to accommodate it. The pins may be of metallic or non-metallic material, provided they are hard enough to embed securely into the metallic conductor. Stainless steel pins are preferred, but alternatively aluminium alloy pins may be used if the conductor is of aluminium or brass pins if it is of copper. Composite pins in which only the radially inner end is of metal may be used in some cases, one of which will be discussed below. The pins could be tubular, but are preferably solid.

Preferably the cut-back end faces of the cable insulation are supported by engagement with relatively rigid material. We prefer to use a hard-setting resinous material to fill and so eliminate all void spaces within the radius of the cable insulation, but another possibility is for the end faces to abut flanges on a joint ferrule or on an auxiliary metal sleeve. Preferably a metal sleeve surrounds the joint area within (and so forming part of) the screen, to assist dissipation of heat from the joint area.

Preferably a rigid (metallic or non-metallic) annular member encircles each cable end at the location of the pin(s) and engages the end(s) of the pin(s), directly or indirectly, to resist any tendency they may have to move radially outwards. For example, this annular member may support grub screws bearing on the ends of individual pins; or if the pins are long enough to project from the insulation surface and are machined if necessary to achieve sufficient dimensional accuracy, the ring may simply be pushed on to engage the pins directly—its bore may be tapered to increase tolerance in radial dimensions if desired. Alternatively a surrounding metal sleeve as described in the preceding paragraph may fulfil this function, and may engage the ends of the pins through a body of resin formed in situ and preferably the same body as fills other void spaces as previously described.

The invention includes a method of making an electric cable joint between two cables each having a metallic conductor surrounded by extruded polymeric insulation comprising cutting back the cable ends to expose the insulation; forming at least one bore extending in a generally radial direction through the insulation of each cable and driving a close-fitting pin through each such bore until it is embedded into the metallic conductor within it, aligning and connecting together contiguous ends of the metallic conductors, and providing screening means extending over the conductor joint and the area of each said pin and a resilient insulating body shrunk onto the cable insulation to insulate the joint.

The invention will be further described, by way of example, with reference to the accompanying drawings in which:

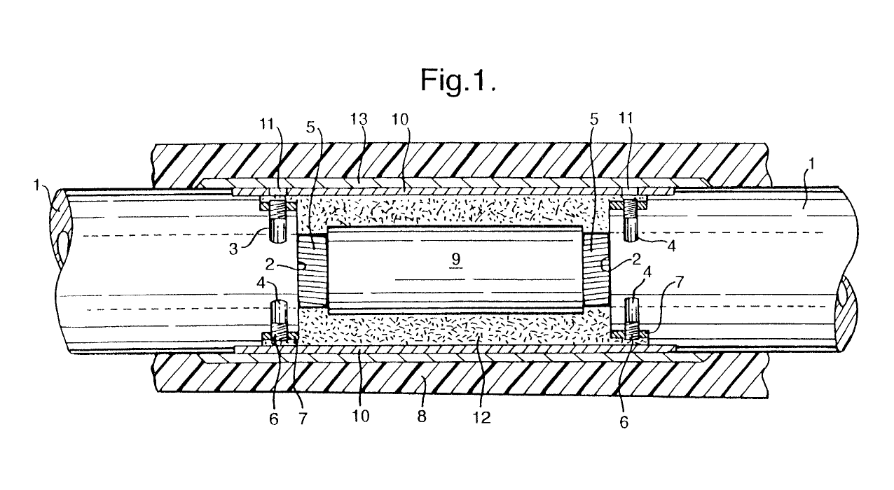

FIG. 1 is a diagrammatic cross-section through a preferred form of cable joint in accordance with the invention; and

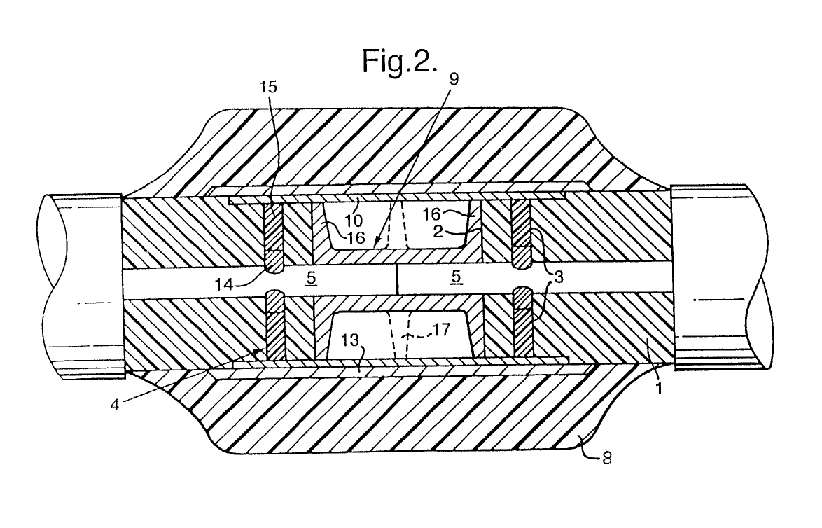

FIG. 2 is a similar cross-section of an alternative form of joint. In each case the conventional outer parts of both cables and joint are omitted for simplicity.

In making the joint shown in FIG. 1, the outer parts of the cables, down to and including the dielectric screen, are stripped back in the normal way to expose the cable insulation 1. Either before or after the insulation is in turn stripped back to form end-faces 2, two or three pairs of bores 3 are drilled substantially through the insulation of each cable end a short distance from the end-faces 2 or the place where they will be formed, as the case may be, and evenly spaced around the circumference. Blunt-ended stainless steel pins 4 are inserted in the bores 3 and driven inwards, pair by pair, using a conventional hydraulic compression tool, so as to become firmly embedded in the metallic conductor 5 of the respective cable, which is of aluminium in this case. The outer ends of the pins 4 are engaged by individual grub screws 6 threaded in respective annular metal bodies 7 to prevent displacement. An insulating sleeve 8, radially stretched and supported by a tubular mandrel (not shown), is threaded over one of the cable ends and temporarily pushed back clear of the joint region—it will be more fully described later. The metallic conductors 5, 5 are now connected together by a compressed or soldered ferrule 9 (or by welding) and a split metal sleeve 10 is assembled round the joint area, extending over the areas of the pins 4: preferably the end of the cut-back insulation is shaved down to accommodate this sleeve without any increase in diameter. The split sleeve 10 is connected electrically to the ferrule (or if there is no ferrule directly to the cable conductors) and has at least one aperture 11 through which a suitably fluid but hardenable resin 12 is injected to fill all void spaces within it. Thus longitudinal forces tending to move the ends of the insulation are resisted by the jointed conductors, while any tendency to distortion is resisted by the resin. The insulating sleeve 8 is now positioned centrally over the conductor joint and collapsed onto it by withdrawing the mandrel using any suitable gripping devices. If the mandrel is split, its parts are separated and returned for re-use: if seamless, it is cut free and discarded. The insulating sleeve 8 has embedded within it a semiconducting insert 13, and this fits over and completely and tightly encloses the split metal sleeve 10 (and the conductor joint and resin within).

Outer parts of the joint are then completed in a conventional way.

In a first modified form of joint (not illustrated), the annular member 7 and grub screws 6 are omitted, and the spaces filled by the resin include the parts of the bores 3 above the tops of the pins 4.

A second modified form of joint is shown in FIG. 2 and is a “dry” option in the sense that the use of fluid resin is avoided. It is similar to the joint of FIG. 1 except for two features: first, the pins 4 are of composite construction with aluminium alloy end parts 14 and hard plastics bodies 15 which can be pared down after driving to finish flush with the prepared surface of the insulation 1 and so be directly supported by the split sleeve 10 without requiring any filling; and second, the ferrule 9 has flanges 16 which tightly abut the insulation end faces 2 to support them against distortion. These flanges also help dissipation of heat from the conductor joint region, and an additional central flange 17 could be added for this purpose if desired. Optionally the spaces between the flanges 16 (or 16 and 17) can be filled with preshaped components of metal or of plastics material, or if preferred by wrapping with tape.

1 An electric cable joint between two cables each having a metallic conductor surrounded by extruded polymeric insulation comprising at least one pin of relatively hard material extending in a generally radial direction through a close-fitting bore in the insulation of each cable and embedded into the metallic conductor within it, contiguous ends of the metallic conductors being aligned and connected together by a conductor joint, screening means extending over the conductor joint and the area of each said pin, and a resilient insulating body shrunk onto the cable insulation to insulate the joint.

2 An electric cable joint as claimed in claim 1 in which the said resilient insulating body forms the whole of the joint insulation.

3 An electric cable as claimed in claim 2 in which the said screening comprises a semiconducting tubular insert within (and forming part of) the resilient insulating body.

4 An electric cable joint as claimed in any one of claims 1-3 in which there is at least one pair of pins for each of the two cable ends.

5 An electric cable joint as claimed in any one of claims 1-3 in which there two or three pairs of pins for each of the two cable ends.

6 An electric cable joint as claimed in any one of claims 1-5 in which the pins are metallic.

7 An electric cable joint as claimed in any one of claims 1-5 in which the pins are of stainless steel.

8 An electric cable joint as claimed in any one of claims 1-5 in which the cable conductors are of aluminium and the pins of an aluminium alloy.

9 An electric cable joint as claimed in any one of claims 1-5 in which the cable conductors are of copper and the pins of brass.

10 An electric cable joint as claimed in any one of claims 1-5 in which the pins are composites in which only the radially inner end is of metal.

11 An electric cable joint as claimed in any one of claims 1-10 in which the cut-back end faces of the cable insulation are supported by engagement with relatively rigid material.

12 An electric cable joint as claimed in claim 11 in which the said relatively rigid material is a hard-set resinous material which fills and so eliminates all void spaces within the radius of the cable insulation.

13 An electric cable joint as claimed in claim 11 in which the said end faces to abut flanges on a joint ferrule or on an auxiliary metal sleeve.

14 An electric cable joint as claimed in any one of claims 1-13 in which a rigid annular member encircles each cable end at the location of the pin(s) and engages the end(s) of the pin(s), directly or indirectly.

15 An electric cable joint as claimed in any one of claims 1-13 in which a rigid annular member encircles each cable end at the location of the pin(s) and engages the end(s) of the pin(s) though grub-screws.

16 An electric cable joint as claimed in any one of claims 1-15 in which a metal sleeve surrounds the joint area within (and so forms part of) the screen.

17 An electric cable joint as claimed in claim 16 in which the said metal sleeve extends over the ends of the pins and engages them, directly or through a body of resin or other intermediate.

18 An electric cable joint substantially as described with reference to FIG. 1.

19 An electric cable joint substantially as described with reference to FIG. 2.

20 A method of making an electric cable joint between two cables each having a metallic conductor surrounded by extruded polymeric insulation comprising cutting back the cable ends to expose the insulation; forming at least one bore extending in a generally radial direction through the insulation of each cable and driving a close-fitting pin through each such bore until it is embedded into the metallic conductor within it, aligning and connecting together contiguous ends of the metallic conductors, and providing screening means extending over the conductor joint and the area of each said pin and a resilient insulating body shrunk onto the cable insulation to insulate the joint.

21 A method of making an electric cable joint as claimed in claim 20 comprising driving at least one pair of pins for each of the two cable ends.

22 A method of making an electric cable joint as claimed in claim 20 or claim 21 comprising driving two or three pairs of pins for each of the two cable ends.

23 A method of making an electric cable joint as claimed in any one of claims 20-22 comprising fitting a rigid annular member to encircle each cable end at the location of the pin(s) and engage the end(s) of the pin(s), directly or indirectly.

24 A method of making an electric cable joint as claimed in any one of claims 20-22 comprising fitting a rigid annular member to encircle each cable end at the location of the pin(s) and threading individual grub-screws in the said rigid annular member to engage the ends of the pins.

25 A method of making an electric cable joint as claimed in any one of claims 20-24 comprising supporting the cut-back end faces of the cable insulation by engagement with relatively rigid material.

26 A method of making an electric cable joint as claimed in claim 25 comprising using as the said relatively rigid material a hard-setting resinous material which is injected into and fills void spaces within the radius of the cable insulation.

27 A method of making an electric cable joint as claimed in claim 25 in which the said end faces are supported by abutting flanges on a joint ferrule or on an auxiliary metal sleeve.

28 A method of making an electric cable joint as claimed in any one of claims 20-27 comprising placing a metal sleeve to surround the joint area within (and so form part of) the screen.

29 A method of making an electric cable joint as claimed in claim 28 comprising dimensioning and placing the said metal sleeve so that it extends over the ends of the said pins and engages them, directly or indirectly.

30 A method of making an electric cable joint substantially as described with reference to FIG. 1.

31 A method of making an electric cable joint substantially as described with reference to FIG. 2.
